(19) United States
(12) Patent Application Publication
(10) Pub. No.: US 2009/0230596 A1
(43) Pub. Date: Sep. 17, 2009

(54) Method of manufacturing multi-layered ceramic substrate

(76) Inventors: Muneyuki Sawada, Osaka (JP); Hidenori Katsumura, Hyogo (JP); Hiroshi Kagata, Osaka (JP)

Correspondence Address: MCDERMOTT WILL & EMERY LLP, 600 13TH STREET, NW, WASHINGTON, DC, 20005-3096, US

(21) Appl. No.: 11/661,681

(22) PCT Filed: Oct. 31, 2006
(86) PCT No.: PCT/JP2006/321686

§ 371 Date: Mar. 2, 2007

(30) Foreign Application Priority Data
Oct. 31, 2005 (JP) 2005-316112

(51) Int. Cl. C04B 33/32

(52) U.S. Cl. 264/642

(57) ABSTRACT

An un-sintered multi-layered body includes a first ceramic layer having a surface, a conductor provided on the surface of the first ceramic layer, an insulator provided on the surface of the first ceramic layer and covering an end of the conductor, and a second ceramic layer provided on the conductor and the insulator. The un-sintered multi-layered body is baked at a temperature at which the first ceramic layer can be sintered but the second ceramic layer cannot be sintered. After the un-sintered multi-layered body is baked, the second ceramic layer is removed, thereby providing a multi-layered ceramic substrate. The insulator has a thickness not smaller than 10 μm and not larger than 40 μm. This method makes the insulator dense and allows the conductor to be formed easily.

### TECHNICAL FIELD

The present invention relates to a method of manufacturing a multi-layered ceramic substrate arranged to have a component, such as a chip component and a semiconductor, mounted thereon.

### BACKGROUND ART

A conventional method of manufacturing a multi-layered ceramic substrate will be described below.

First, inorganic powder containing glass component is mixed with, e.g. organic binder and plasticizer, thereby providing plural first ceramic layers. Then, conductive paste is printed on these layers as to form conductors. Inorganic powder is mixed with, e.g. organic binder and plasticizer, thereby providing two of second ceramic layers which cannot be sintered at a sintering temperature of the first ceramic layer. Then, conductive paste is printed on one of the two layers to form a conductor.

Next, the first ceramic layers having the conductors printed thereon are stacked on one after another. Then, the second ceramic layer having no conductor thereon is stacked on a surface of the first ceramic layer having the conductor printed thereon. The second ceramic layer having the conductor printed thereon is stacked on the surface of the first ceramic layer having no conductor thereon. Then, these stacked layers are heated and pressurized, thereby providing an un-sintered multi-layered body.

Then, this un-sintered multi-layered body is baked at a temperature at which the first ceramic layer can be sintered but the second ceramic layer cannot be sintered. At this moment, the second ceramic layer is not sintered and does not shrink so much, hence restricting the first ceramic layer which is to shrink due to the sintering. The second ceramic layer can thus prevent the first layer from shrinking along directions along the surface of the first ceramic layer.

Then, only the second ceramic layer which is not sintered is removed, thereby providing a multi-layered ceramic substrate having a precise flatness. This method of manufacturing the multi-layered ceramic substrates is called, in general, a shrink-free baking method.

Various components, e.g. chip components, such as chip capacitors, chip inductors, and chip resistors, or semiconductor components, such as pin-diodes, are mounted to the multi-layered ceramic substrate by soldering them with terminal electrodes of the substrate, thereby providing a ceramic module.

This ceramic module can be mounted to a printed circuit board by soldering, so that they can be used mainly in small electronic devices, such as portable phones.

However, high-frequency modules used in portable devices, such as portable phones, have recently required ceramic substrates having large mechanical resistance to dropping. The portable devices may cause cracks or breakage at terminal electrodes used for mounting the components to printed circuit boards.

Japanese Patent Laid-Open Publication No. 2002-111165 discloses a structure of covering the end of a terminal electrode with an insulator in order to prevent the cracks or breakage.

Japanese Patent Laid-Open Publication No. 2003-243827 discloses a shrink-free baking method that can prevent the cracks or breakage. This method adopts the structure of covering the end of the terminal electrode with the insulator. In this method, the insulator is formed on the second ceramic layer, and then, the conductor is formed on the layer, namely, the conductor is stacked on the insulator, and they are baked, thereby being united.

In processes of forming the insulator on the second ceramic layer and then the conductor is formed on the insulator, these conventional methods discussed above, the conductor is formed by screen printing in a recess provided in the insulator, thereby causing print-blurring.

The insulator is formed by the screen-printing as well as the conductor. Insulating paste used in the printing of the insulator includes 65 to 80 wt % of solid component. Coating film formed by printing this paste has a low density. When the first ceramic layer and the second ceramic layer are stacked and pressed together, the second ceramic layer serves as a cushion, hence preventing the density of the coating film made of the insulating paste from increasing. As a result, when the conductor is plated, plating solution infiltrates into the interface between the conductor and the first ceramic layer, thereby peeling the conductor off.

### SUMMARY OF THE INVENTION

An un-sintered multi-layered body includes a first ceramic layer having a surface, a conductor provided on the surface of the first ceramic layer, an insulator provided on the surface of the first ceramic layer and covering an end of the conductor, and a second ceramic layer provided on the conductor and the insulator. The un-sintered multi-layered body is baked at a temperature at which the first ceramic layer can be sintered but the second ceramic layer cannot be sintered. After the un-sintered multi-layered body is baked, the second ceramic layer is removed, thereby providing a multi-layered ceramic substrate. The insulator has a thickness not smaller than 10 μm and not larger than 40 μm.

This method makes the insulator dense and allows the conductor to be formed easily.

### BRIEF DESCRIPTION OF THE DRAWINGS

FIG. 1 is a sectional view of a multi-layered ceramic substrate for illustrating a method of manufacturing the substrate in accordance with an exemplary embodiment of the present invention.

FIG. 2 is a sectional view of the multi-layered ceramic substrate for illustrating the method of manufacturing the substrate in accordance with the embodiment.

FIG. 3 is a sectional view of the multi-layered ceramic substrate for illustrating the method of manufacturing the substrate in accordance with the embodiment.

FIG. 4 is a schematic diagram illustrating a process of manufacturing the multi-layered ceramic substrate in accordance with the embodiment.

FIG. 5 is a sectional view of the multi-layered ceramic substrate for illustrating the method of manufacturing the substrate in accordance with the embodiment.

FIG. 6 shows evaluation results of the multi-layered ceramic substrate in accordance with the embodiment.

FIG. 7 is a sectional view of the multi-layered ceramic substrate for illustrating the method of manufacturing the substrate in accordance with the embodiment.

FIG. 8 is a sectional view of the multi-layered ceramic substrate for illustrating the method of manufacturing the substrate in accordance with the embodiment.

FIG. 9 is a sectional view of the multi-layered ceramic substrate for illustrating the method of manufacturing the substrate in accordance with the embodiment.

FIG. 10 is a sectional view of the multi-layered ceramic substrate for illustrating the method of manufacturing the substrate in accordance with the embodiment.

FIG. 11 is a sectional view of the multi-layered ceramic substrate for illustrating the method of manufacturing the substrate in accordance with the embodiment.

FIG. 12 shows evaluation results of the multi-layered ceramic substrates in accordance with the embodiment.

FIG. 13 shows evaluation results of the multi-layered ceramic substrates in accordance with the embodiment.

### REFERENCE NUMERALS

11 First Ceramic Layer
12 Second Ceramic Layer
13A Conductor
13B Conductor
13C Conductor
15 Insulator
17 Press Roller

### DESCRIPTION OF THE PREFERRED EMBODIMENT

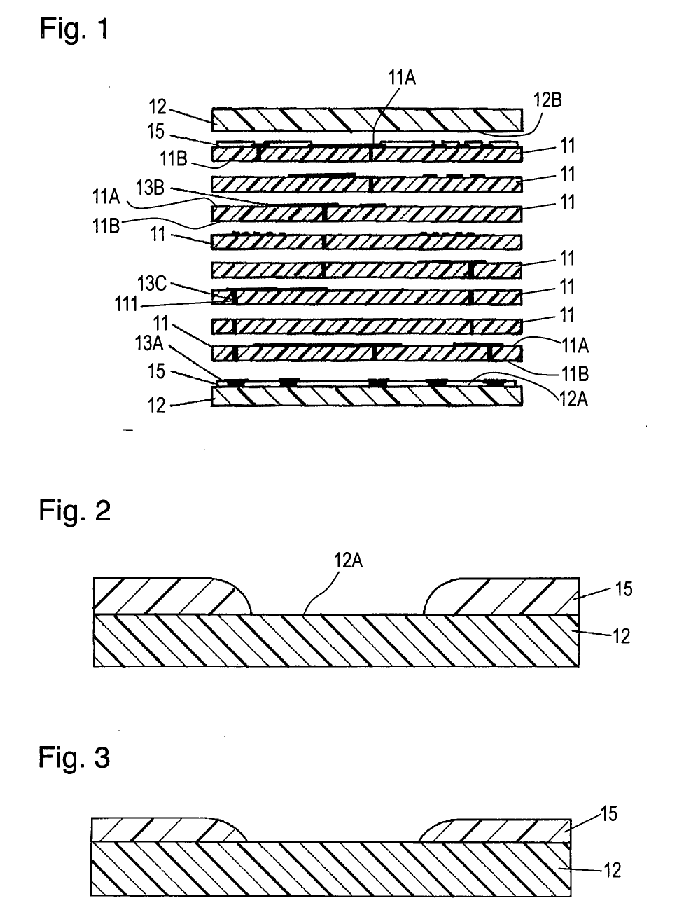

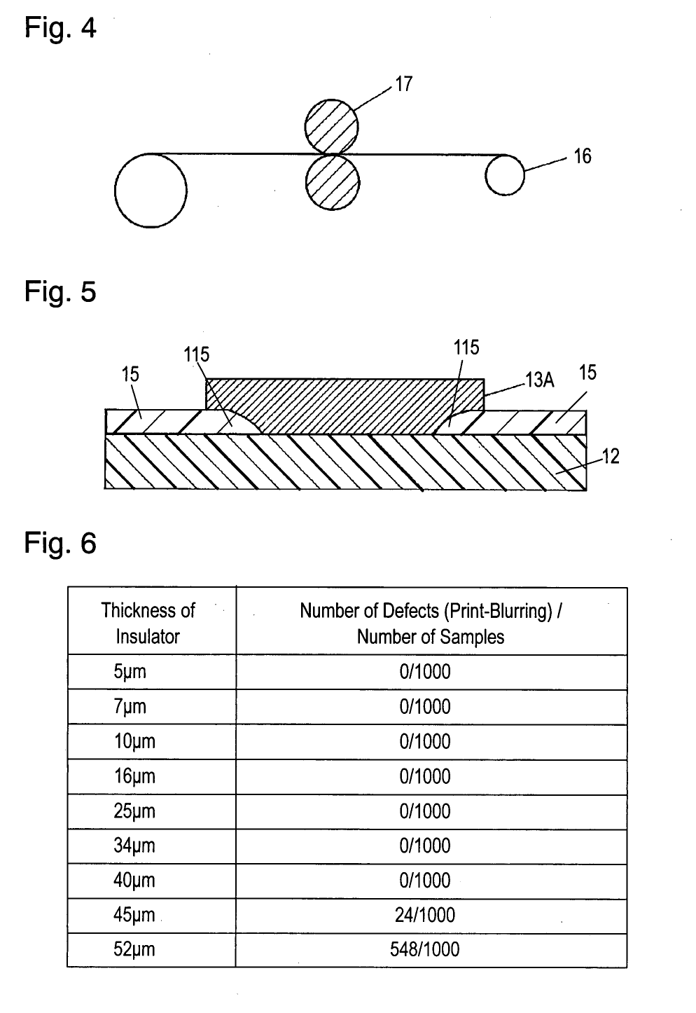

FIGS. 1 to 3 and FIGS. 5 to 11 are sectional views of a multi-layered ceramic substrate for illustrating a method of manufacturing the substrate in accordance with an exemplary embodiment of the present invention. FIG. 4 is a schematic diagram for illustrating a process of manufacturing the multi-layered ceramic substrate.

In FIG. 1, first ceramic layer 11 contains inorganic powder, such as aluminum oxide, and glass component. Second ceramic layer 12 contains inorganic powder, such as aluminum oxide. Conductors 13A, 13B, and 13C contains metal, such as Ag, Pt, Pd, Cu, W, Mo, and Ni, and can be sintered at a temperature at which first ceramic layer 11 is sintered. Insulator 15 is provided on second ceramic layer 12.

The inorganic powder, such as aluminum oxide, is mixed with glass component, organic binder, and plasticizer for producing first ceramic layer 11. First ceramic layer 11 contains a large amount of glass component, accordingly being sintered at a low temperature. First ceramic layer 11 has a thickness ranging from 5 to 300 μm.

Next, via-holes 111 are formed in first ceramic layer 11 by mechanical punching or laser beam, and are filled with conductive paste, thereby forming conductor 13C. Conductor 13B is formed by screen printing on surface 11A of first ceramic layer 11 in order to form circuit elements, such as a capacitor and an inductor. First ceramic layer 11 has nothing on surface 11B thereof opposite to surface 11A.

The inorganic powder, such as aluminum oxide, is mixed with organic binder and plasticizer, thereby producing second ceramic layer 12. Second ceramic layer 12 is sintered at a temperature higher than the sintering temperature of first ceramic layer 11, hence not shrinking so much at the sintering temperature of first ceramic layer 11.

Then, as shown in FIG. 2, insulating paste is applied onto surface 12A of second ceramic layer 12 by the screen printing, thereby forming insulator 15. The insulating paste contains preferably 65 to 80 wt % of solid component, more preferably not less than 70 wt % of the solid component, thereby having a thickness controlled easily.

Next, as shown in FIG. 3, second ceramic layer 12 and insulator 15 are pressed together, so that insulator 15 becomes thinner. If second ceramic layer 12 has a rectangular shape, second ceramic layer 12 having insulator 15 thereon is pressed with a flat press platen. In order to increase productivity, as shown in FIG. 4, insulator 15 is formed on roll 16 of the second ceramic layer having a roll shape, and then, insulator 15 and roll 16 are pressed together with press roller 17, thereby making insulator 15 thinner.

Then, as shown in FIG. 5, conductor 13A is formed on surface 12A of second ceramic layer 12 as to cover ends 115 of insulator 15. Ends 115 of insulator 15 are placed between second ceramic layer 12 and conductor 13A. Insulator 15 contains the inorganic material identical to the material contained in first ceramic layer 11.

It was investigated that the thickness of insulator 15 and print-blurring of conductor 13A, the phenomenon that conductor 13A is not printed on a place where the conductor is to be printed. FIG. 6 shows the total number of samples and the number of samples having the print-blurring of insulator 15. As shown in FIG. 6 the thickness of insulator 15 not greater than 40 μm does not cause the print-blurring of insulator 15, however, the thickness of insulator 15 greater than 40 μm may cause the print-blurring of insulator 15.

Then, as shown in FIG. 1, first ceramic layer 11 having conductors 13A and 13B formed thereon is stacked on second ceramic layer 12 having insulator 15 and conductor 13A formed thereon, so that conductor 13A contacts surface 11B of first ceramic layer 11. Then, the layers are pressed with a first pressure and heated, thereby uniting first ceramic layer 11, second ceramic layer 12, insulator 15, conductors 13A and 13B.

Then, another first ceramic layer 11 is stacked on surface 11A of first ceramic layer 11 having conductors 13A and 13B formed thereon, so that surface 11B of another layer 11 contacts surface 11A of first ceramic layer 11. The layers are heated and pressed, thereby being united. As shown in FIG. 1, surface 11A of first ceramic layer 11 having conductor 13B thereon is positioned at the upper most. Ends 113B of conductor 13B are placed between insulator 15 and first ceramic layer 11.

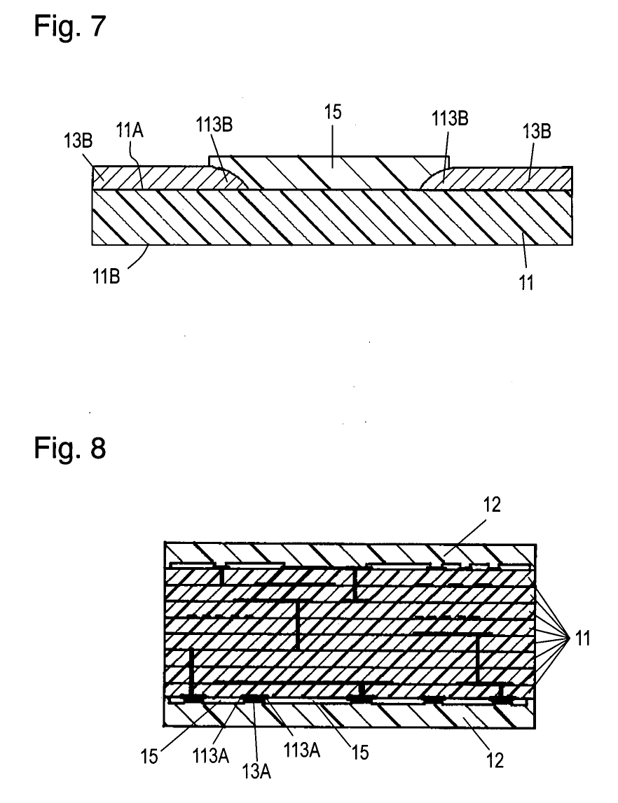

FIG. 7 is an enlarged sectional view of conductor 13B and first ceramic layer 11 positioned at the upper most. As shown in FIG. 7, the insulating paste is printed on first ceramic layer 11 to cover ends 113B of upper most conductor 13B, thus forming insulator 15. The thickness of insulator 15 contacting conductor 13B positioned at the upper most may not necessarily range from 10 μm to 40 μm.

Then, second ceramic layer 12 is stacked on insulator 15 and conductor 13B, so that surface 12B contacts insulator 15 and conductor 13B, and then, is heated and pressed to be united, thereby providing a non-pressurized multi-layered block shown in FIG. 8.

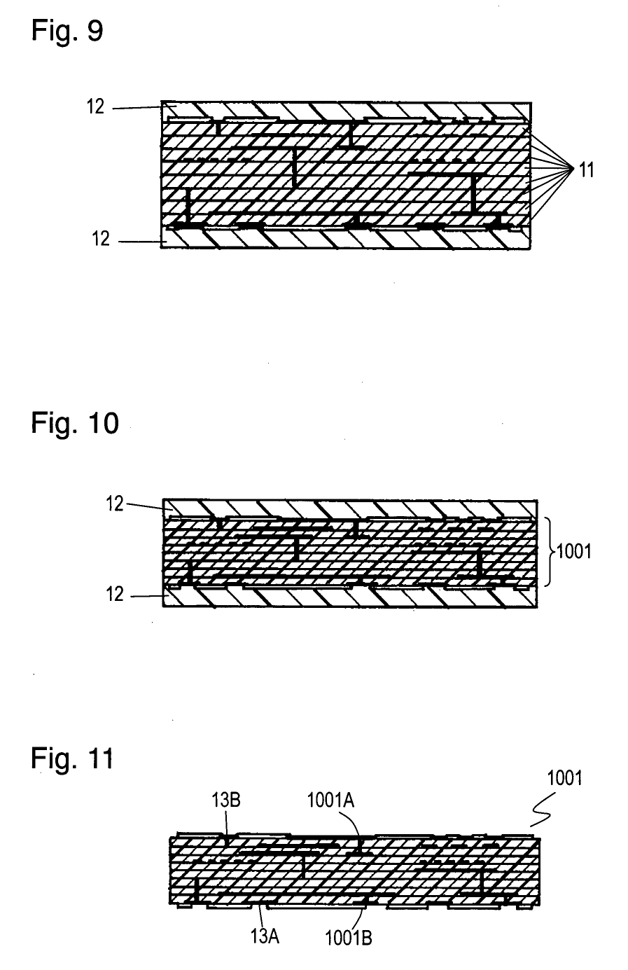

Next, this non-pressurized multi-layered block is pressed with a pressure greater than the first pressure for the previous pressing, thereby providing an un-sintered multi-layered body shown in FIG. 9. In this un-sintered multi-layered body, ends 113A of conductor 13A are placed between insulator 15 and first ceramic layer 11.

Then, the un-sintered multi-layered body is baked at a temperature at which first ceramic layer 11 and conductors 13A, 13B, and 13C are sintered but second ceramic layer 12 cannot be sintered or hardly shrinks, thereby providing multi-layered ceramic substrate 1001 shown in FIG. 10. This baking temperature is higher than the temperature at which first ceramic layer 11, conductors 13A, 13B and 13C can be sintered, and is lower than the temperature at which second ceramic layer 12 can be sintered. Since second ceramic layer 12 does not shrink during this baking, second ceramic layer 12 restricts first ceramic layer 11 from shrinking due to the sintering. Second ceramic layer 12 thus can suppress the shrinking of first ceramic layer 11 in directions in parallel with surfaces 11A and 11B of first ceramic layer 11.

Then, second ceramic layer 12 which is not sintered is removed, thereby providing multi-layered ceramic substrate 11 having a precise flatness shown in FIG. 11. Since second ceramic layer 12 is not sintered, layer 12 can be removed easily without damage to first ceramic layer 11 and conductors 13A and 13B.

Being covered with insulator 15, ends 113A and 113B of conductors 13A and 13B have a large strength, and conductors 13A, 13B have large resistance to shocks, thus being prevented from having structural defects, such as cracks.

Insulator 15 contains the inorganic material identical to that of first ceramic layer 11. This allows insulator 15 to react with first ceramic layer 11 during the baking and to be bound firmly to first ceramic layer 11, thus being bonded to first ceramic layer 11 with a large bonding strength.

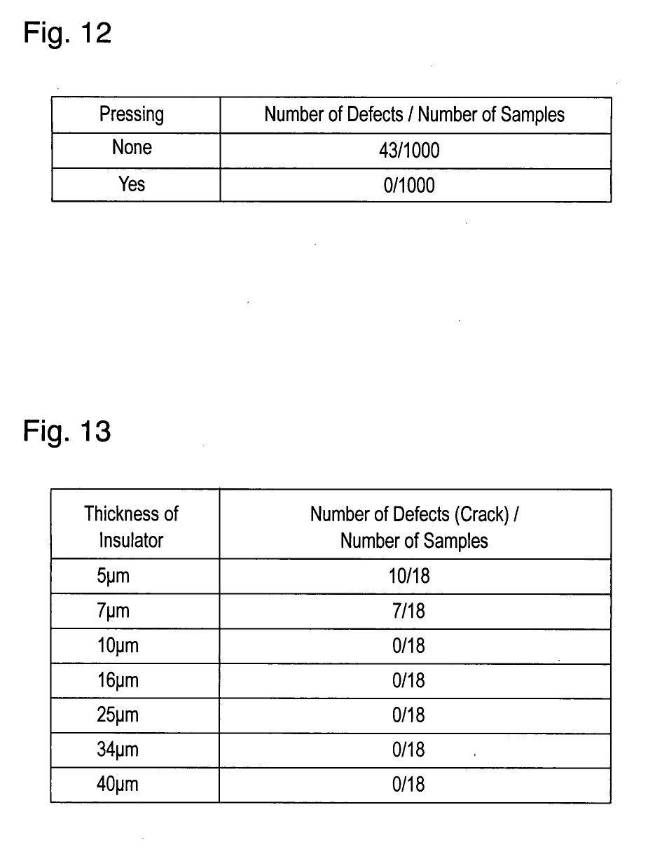

Conductors 13A and 13B exposing from multi-layered ceramic substrate 1001 are generally plated with metal, such as Ni—Au plating, in order to obtain wettability to solder. Samples of multi-layered ceramic substrate 1001 were prepared, and provided with the Ni—Au plating. Then, it was investigated whether plating solution infiltrates between insulator 15 and conductor 13A or not. The Infiltration of the plating solution between insulator 15 and conductors 13A and 13B may cause defects of conductors 13A and 13B having portions beneath insulator 15 plated, or may cause defects of conductors 13A and 13B peeled off from substrate 1001. FIG. 12 shows the number of samples each including second ceramic layer 12 pressed shown in FIG. 3, the number of samples each including layer 12 not being pressed, and the number of samples having the defects.

As shown in FIG. 12, the samples each including second ceramic layer 12 not being pressed included the defects, however, the samples each including layer 12 did not include the defects. The pressure applied in this investigation is preferably not greater than the pressure applied to the non-pressurized multi-layered ceramic block.

Chip components, such as surface acoustic wave filters, and semiconductors, such as diodes, are mounted to surface 1001A of multi-layered ceramic substrate 1001, and conductor 13A on surface 1001B is mounted to a circuit board, thereby providing an electronic device having a small size and excellent characteristics.

Samples of multi-layered ceramic substrate 1001 in accordance with this embodiment and comparative samples of multi-layered ceramic substrates were evaluated in a dropping test. An insulator of each of the comparative samples corresponding to insulator 15 did not cover an end of a conductor. Both of the samples had the same dimensions of a length of 6.7 mm by a width of 5.0 mm by a thickness of 0.7 mm. These samples of the multi-layered ceramic substrates were mounted onto printed circuit boards respectively, and the outer peripheries of the printed circuit boards were fitted in frames made of metal having a weight of 150 g. Then, the samples filled in the frames were dropped from the height of 1.8 m while the respective surfaces faced downward three times per each surface. Most of the comparative samples of the multi-layered ceramic substrates had cracks.

The samples of multi-layered ceramic substrate 1001 in accordance with the embodiment including insulators 15 having various thicknesses were prepared, and subjected to the same dropping test. FIG. 13 shows the number of the samples in accordance with the embodiment, the number of the comparative samples, and the number of samples having the cracks.

As shown in FIG. 13, substrate 1001 in accordance with the embodiment includes conductors 13A and 13B having the ends covered with insulator 15, hence being prevented from the cracks caused by the shock due to the dropping. However, insulator 15 thinner than 10 μm does not prevent the cracks sufficiently.

In the manufacturing method in accordance with the embodiment, the thickness of insulator 15 of the un-sintered multi-layered body is not smaller than 10 μm and not lager than 40 μm. This thickness provides the multi-layered ceramic substrate having large resistance to mechanical shocks.

In the manufacturing method in accordance with the embodiment, conductors 13A and 13B exposing from substrate 1001 are baked together with ceramic layers 11 and 12. This process reduces the number of processes in comparison with a method of forming conductors by burning after the baking, thus increasing productivity.

### INDUSTRIAL PRODUCTIVITY

A method of manufacturing a multi-layered ceramic substrate according to the present invention provides the multi-layered ceramic substrate having large resistance to mechanical shocks, thus being useful for a multi-layered ceramic substrate to be used as composite components with filters, semiconductors, and SAW filters.

1. A method of manufacturing a multi-layered ceramic substrate, comprising:
forming an un-sintered multi-layered body which includes
a first ceramic layer having a surface,
a conductor provided on the surface of the first ceramic layer,
an insulator provided on the surface of the first ceramic layer, the insulator having a thickness not smaller than 10 μm and not larger than 40 μm, the insulator covering an end of the conductor, and
a second ceramic layer provided on the conductor and the insulator;
baking the un-sintered multi-layered body at a temperature at which the first ceramic layer can be sintered but the second ceramic layer cannot be sintered; and
after said baking of the un-sintered multi-layered body, removing the second ceramic layer from the un-sintered multi-layered body.

2. The method according to claim 1, wherein said forming of the un-sintered multi-layered body comprises:
forming the insulator on a surface of the second ceramic layer; and
after said forming of the insulator on the surface of the second ceramic layer, pressurizing the insulator toward the second ceramic layer.

3. The method according to claim 2, wherein said pressurizing of the insulator toward the second ceramic layer comprises pressurizing the insulator toward the second ceramic layer with a press roller.

4. The method according to claim 2, wherein said forming of the un-sintered multi-layered body comprises, after said pressurizing of the insulator toward the second ceramic layer, forming the conductor on the surface of the second ceramic layer, so that the conductor covers an end of the insulator.
